(19) United States
(12) Patent Application Publication
(10) Pub. No.: US 2019/0032627 A1
(43) Pub. Date: Jan. 31, 2019

(54) Method and Apparatuses for Generating-Green Energy Source- using the weight of Tidal Body of Water

(71) Applicant: Qussay Abdulatteef Jasim Al-Aani, TAMPA, FL (US)

(72) Inventor: Qussay Abdulatteef Jasim Al-Aani, TAMPA, FL (US)

(21) Appl. No.: 15/926,964

(22) Filed: May 25, 2018

Related U.S. Application Data
(60) Provisional application No. 62/601,694, filed on Mar. 27, 2017.

(51) Int. Cl. F03B 13/26

(52) U.S. Cl. CPC F03B 13/266; F03B 17/025

(57) ABSTRACT

By Using the above two methods with the same principals but different methods and apparatus for rotating electricity generators shafts or pressurizing fluids using the weight of the tidal body of water using Moving Tanks, reservoirs channels A & B for high and low tide separated from sea using digital gates fill the channel A and close when tide level falls, Similarly channel B gate open and empty to the sea at lowest level, Electricity Station between the channels and the Containers replenished with water from high tide reservoir (will be held until full using counterweights), then falls and empty into the low tide reservoir which make the green energy station very much in demand due to its low cost

### BACKGROUND OF THE INVENTION

The present invention relates to a method and apparatus for pressurizing fluid using the weight of a tidal body of water, and more particularly relates to using the pressurized fluid to generate electricity.

Much electricity is generated from fossil fuels but these fuels are not renewable and the generation process causes significant environmental pollution, more environmentally friendly ways of generating Electricity include, harnessing the power of the wind, using solar energy, and harnessing the power of the sea.

Wind may be used to drive wind turbines and these turbines have low maintenance and cause low pollution, construction costs though are generally higher per watt generated than with conventional fossil fuel power plants.

The energy of the sun may be captured by solar panels, solar panels generally require small-scale power generators and large numbers of them are required to produce a significant amount of electricity entailing high costs.

Solar energy cells are very unreliable because of night stops and the efficiency drops significantly when the sun is not shining on them, the glass covers of the cells can require continuous cleaning to ensure the efficient collection of solar rays, replacing the panels due to breakage caused by high winds, hail, etc adds to the cost of using solar power.

One way of generating power from the sea is to use the waves to oscillate floating buoys wherein the oscillation of the buoys is used to drive generators another way involves using waves to drive hydraulic rams in floating cylinders, the rams pump oil through hydraulic motors and they drive generators inside the cylinders, further way involves having oscillating seawater in a column wherein as the sea rises it pushes air or another fluid in the column above it and this movement of fluid drives an electrical generator at the top of the column, these systems are small scale and would require a large number of them to produce a significant amount of electricity.

Another way of generating power from the sea uses a wave focusing system wherein waves breaking on the shore are channeled via a plurality of channels into a reservoir and as the water flows back out of the reservoir the water drives generators connected to the channels.

### SUMMARY OF THE INVENTION

The present invention relates to a method and apparatus for producing energy {Electricity, Water Desalination (potable water) etc} using sea Tidal Body of Water weight (Green Energy Source), by the fast filling and emptying of one or a plurality of containers to pressurize the fluid in the plurality of cylinders, or one to pressurize a turbine or water Desalination or to thereby rotate a crank shaft of engines to generate green energy, and more particularly relates to using the tidal sea water to generate electricity

All the above systems generate power in real-time whilst the sea is moving, and not necessarily when the power is required.

It is an object of the present invention to provide a method and apparatus to produce continues Green Energy 24 hours a day and night and alleviate the above-mentioned problems.

According to one aspect of the present invention

There are two methods of pressurizing fluid using a tidal body of water, described in this patent comprising the steps of (FIG. 1 to FIG. 12) for The Floating Tanks Methods &apparatuses and (FIG. 14 to FIG. 23) for The Two or several Moving Tanks method apparatuses

1) The Floating Tanks Method apparatuses,

Described in this patent comprising the steps of;

(a) providing a main reservoir separated from the tidal body of water;
(b) Providing a floating container floating in the main reservoir;
(c) Siphoning water from the floating container so that the floating container rises as a consequence of buoyancy;
(d) Replenishing the floating container with water from the tidal body of water when a surface of the tidal body of water is higher than a surface of water in the floating container so that the floating container falls as a consequence of its reduced buoyancy; and
(e) Reciprocating a piston and cylinder arrangement by means of a physical connection between the floating container and the piston and cylinder arrangement so as to pressurize fluid by means of the piston and cylinder arrangement ‘or rotate generator shaft this is repeated on continuous bases.

The difference between the low and high tide levels of the tidal body of water varies according to location and where the tidal body of water is a sea the range is between 1 and 4 meters. The method is able to pressurize fluid across this range.

By harnessing the tidal movement of the body of water, the method is able to provide a clean source of pressurized fluid. As the floating container can hold a large weight of water when it is replenished and the cross-sectional area of the cylinder containing the piston is relatively small, high pressure is achieved forming a concentrated source of power.

The pressurized fluid may be water and the method preferably includes supplying the pressurized fluid to a device.

The device may comprise turbine means and the method includes generating electricity with the turbine means. Thus, the method can provide a clean source of electricity.

Alternatively, the device may comprise reverse osmosis equipment and the method includes using the pressurized fluid when it is water to produce potable water, Existing reverse osmosis equipment may require motorized pumps to supply pressurized water but these motors are not required for the above method.

Fluid may be drawn into the cylinder as the floating container rises.

Step (e) of the method may include operating valve means to control entry and exit of fluid to and from the cylinder, this enables pressurized fluid to be supplied when it is required.

The floating container may be connected to one of the piston and the cylinder so as to move up and down therewith or rotate a generator shaft.

Alternatively, the floating container may be connected to one of the piston and the cylinder by a lever and moves up and down in opposition to the floating container.

Step (e) of the method may include drawing water into the cylinder from the floating container as the floating container rises.

Step (c) may include siphoning water from the floating container into a siphoned water reservoir. The method may include a further step of transferring water from the siphoned water reservoir to the tidal body of water when a surface of the water in the siphoned water reservoir is higher than the surface of the tidal body of water, water leaving a said device supplied with pressurized water may be supplied to the siphoned water reservoir.

According to another aspect of the present invention there is provided an apparatus for pressurizing fluid using a tidal body of water, comprising:

A main reservoir arranged to be separated from the tidal body of water;

A floating container floating in the main reservoir,

Siphoning means to siphon water from the floating container so that the floating container rises as a consequence of buoyancy;

Replenishing means for replenishing the floating container with water from the tidal body of water when a surface of the tidal body of water is higher than a surface of water in the floating container so that the floating container falls as a consequence of its reduced buoyancy; and a piston and cylinder arrangement with a physical connection to the floating container, wherein the piston and cylinder arrangement is reciprocated via the physical connection so as to pressurize fluid by means of the piston and cylinder arrangement.

After construction costs, the apparatus can provide pressurized fluid at very low cost.

The apparatus may include a plurality of piston and cylinder arrangements.

The apparatus may include a plurality of fluid pressurizing systems connectable to a device wherein each system comprises the main reservoir, the floating container and the piston and cylinder arrangement, and the pressurized fluid from at least one of the systems is arranged to be supplied to the device.

Controlling means may be provided to control the flow of pressurized fluid from any of the fluid pressurizing systems to provide a regular flow of pressurized fluid to the device, the device may comprise turbine means for generating electricity from the supplied pressurized fluid, the device may comprise reverse osmosis equipment for producing potable water from the supplied pressurized fluid when the supplied pressurized fluid is water.

According to yet another aspect of the present invention there is provided a method of generating electricity from a tidal body of water, comprising the steps of

(a) providing a main reservoir separated from the tidal body of water;
(b) Providing a floating container floating in the main reservoir, the floating container connected to a first part of a lever;
(c) Siphoning water from the floating container so that the floating container rises as a consequence of buoyancy;
(d) replenishing the floating container with water from the tidal body of water when a surface of the tidal body of water is higher than a surface of water in the floating container so that the floating container falls as a consequence of its reduced buoyancy; and
(e) moving a second part of the lever up and down in opposition to the floating container so as to drive a dynamo means to produce electricity.

According to a still further aspect of the present invention there is provided an apparatus for generating electricity from a tidal body of water, comprising:
a main reservoir arranged to be separated from the tidal body of water,
a floating container floating in the main reservoir,
a lever having a first part connected to the floating container,
siphoning means to siphon water from the floating container so that the floating container rises as a consequence of buoyancy;

Replenishing means for replenishing the floating container with water from the tidal body of water when a surface of the tidal body of water is higher than a surface of water in the floating container so that the floating container falls as a consequence of its reduced buoyancy; and dynamo means connected to a second part of the lever, wherein the second part is arranged to be moved up and down in opposition to the floating container so as to drive the dynamo means to produce electricity.

Another aspect of the patent is to use another apparatus design but with the same patent principals and ideas (FIG. 14 to FIG. 23) for The Two or several Moving Tanks method apparatuses:

An alternative to the present invention provides system for generating green energy from a tidal body of water, the system comprises a tank located at approximately a high tide level and configured to receive and be filled with sea water when the tide is high; first and second normally-closed tank valves (FIG. 14 VALVE 24A) in the bottom of the tank; a reservoir located at approximately a low tide level, first and second cantilever arms located below the tank and above the reservoir, each cantilever arms connected at an inner end to a crankshaft configured to power a device, the first and second cantilever arms are pivotal between a raised position and a lowered position such that when the first cantilever arm is in the raised position, the second cantilever arm is in the lowered position, a first container secured to an outer end of the first cantilever arm and a second container secured to an outer end of the second cantilever arm, the first and second containers positioned under the first and second tank valves, respectively, and first and second normally-closed container (FIG. 14 VAVE 18B) valves in the bottom of the first and second containers, respectively, when the first cantilever arm is in the raised position, the first tank valve is opened and allows water to flow out of the tank into the first container and simultaneously the second cantilever arm is in the lowered position, the second container valve is opened and allows water to flow out of the second container into the reservoir, when the first container is filled to a predetermined level and the second container is empty, the first cantilever arm moves to the lowered position and the second cantilever arm moves to the raised position, when the second cantilever arm is in the raised position, the second tank valve is opened and allows water to flow out of the tank into the second container and simultaneously the first cantilever arm is in the lowered position, the first container valve is opened and allows water to flow out of the first container into the reservoir and when the second container is filled to a predetermined level (FIG. 19) of the water release counter weight system, and the first container is empty, the second cantilever arm moves to the lowered position and the first cantilever arm moves to the raised position. The raising and lowering of the first and second cantilever arms drives the crankshaft, thereby powering the device.

After construction costs, the apparatus can provide Electricity and fresh water and Energy at very low cost.

### DESCRIPTION OF THE DRAWINGS

Elements in the figures have not necessarily been drawn to scale in order to enhance their clarity and improve understanding of these various elements and embodiments of the invention.

Furthermore, elements that are known to be common and well understood to those in the industry may not be depicted in order to provide a clear view of the various embodiments of the invention; thus the drawings are generalized in form in the interest of clarity and conciseness FIG. 13) Generalized diagram of a Steam-driven Electric Power Plant, a type of thermal power plant

(FIG. 1 to FIG. 12) DRAWINGS for the Floating Tanks Methods &apparatuses

Embodiments of the present invention will now be described, by way of example, with reference to the accompanying schematic drawings (SHORT DRAWINGS DESCRIPTION AND FULL DESCRIPTION FURTHER DOWN), in which:

FIG. 1 is a view of an apparatus for pressurizing fluid using a tidal body of water according to one embodiment of the invention;

FIG. 2 to FIG. 4 are views of the apparatus in various stages of use;

FIG. 5 is a view of the apparatus having reverse osmosis equipment;

FIG. 6 is a view of a high tide storage reservoir for the apparatus;

FIG. 7 is a view of a modified apparatus for driving a dynamo;

FIG. 8 and FIG. 9 are views of an apparatus according to a second embodiment of the invention based on FIG. 1 and FIG. 2, respectively;

FIG. 10 is a view of a water pressurizing system forming a modified part of the apparatus shown in FIG. 9;

FIG. 11 is a view of an apparatus having a plurality of water pressurizing systems; and

FIG. 12 is a plan view of another apparatus having a plurality of water pressurizing systems.

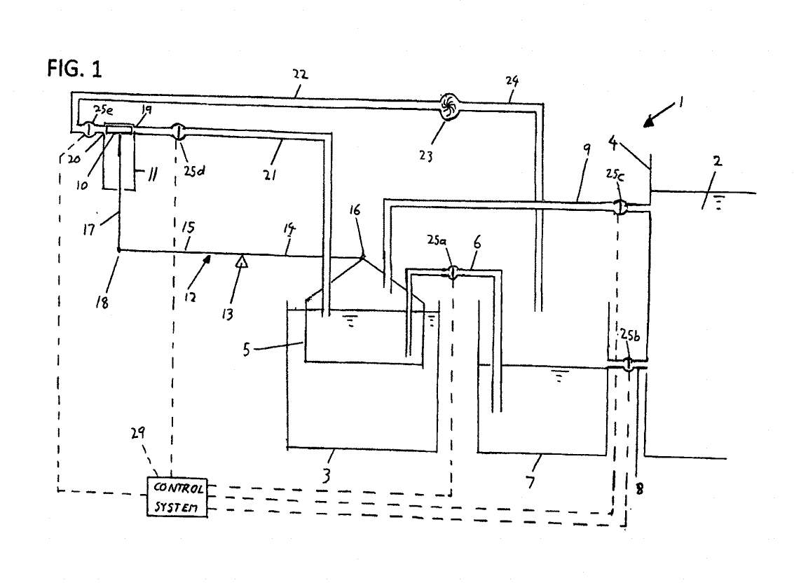

Referring to FIG. 1 of the accompanying drawings, an apparatus 1 for Pressurizing fluid using a tidal body of water 2, comprises a main reservoir 3 Separated from the tidal body of water 2 by a barrier 4. The main reservoir 3 Contains water and has a container 5 floating in it and the floating container 5 Does not touch the sides of the reservoir 3. A siphoning conduit 6 is arranged to siphon water from the floating container 5 into a siphoned water reservoir 7 and is fixed to the floating container 5. A siphoned water reservoir exit conduit 8 connects the siphoned water reservoir 7 to the tidal body of water 2 on the other side of the barrier 4 to the apparatus 1. A replenishing conduit 9 is arranged to replenish the floating container 5 with water from the tidal body of water 2 on the other side of the barrier 4 to the apparatus 1 when a surface of the tidal body of water 2 is higher than a surface of water in the floating container 5.

The floating container 5 is connected to a piston 10 in a cylinder 11 via a lever 12 that is pivoted about a pivot 13. The lever 12 has first and second lever portions 14, 15 on respective sides of the pivot 13. The floating container 5 is connected to the distal end of the first lever portion 14 by a joint 16. The piston 10 has a piston shaft 17 that extends out of the cylinder 11 and the distal end of 25 the piston shaft 17 is connected by a joint 18 to the distal end of the second lever portion 15. There is a first port 19 on one side of the cylinder 11 and a second port 20 on the opposite side of the cylinder 11 with both ports 19, 20 being proximate the top of the cylinder 11. A piston cylinder floating container conduit 21 extends from the first port 19 into the floating container 5. A piston cylinder turbine conduit 22 connects the second port 20 to an entrance to a turbine means 23. A turbine exit conduit 24 extends from an exit from the turbine means 23 to the top of the siphoned water reservoir 7.

The siphoning conduit 6, the siphoned water reservoir exit conduit 8, the replenishing conduit 9, the piston cylinder floating container conduit 21 and the piston cylinder turbine conduit 22, each have a respective control valve 25a, 25b, 25c, 25d, 25e and these are controlled by a control system 29 (shown in FIG. 1 only for clarity).

In use, the floating container 5 is filled with water and floats in the main reservoir 3. This may be by opening the replenishing conduit valve 25c when the tidal body of water 2 is towards or at high tide level. The siphoned water reservoir 7 contains enough water so that either end of the siphoning conduit 6 is in water and the surface of the water in the siphoned water reservoir 7 is at a lower level than the surface of the water in the floating container 5. The end of the piston cylinder floating container conduit 21 distal from the cylinder 11 is in the water in the floating container 5. All the control valves 25a, 25b, 25c, 25d, 25e are closed (see FIG. 1).

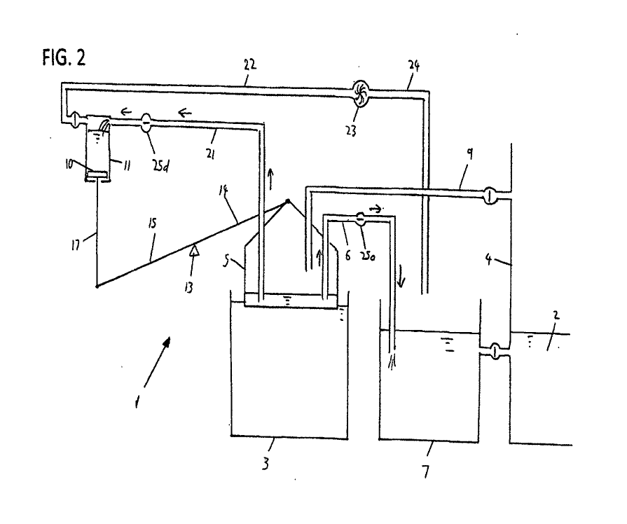

The siphoning conduit and the piston cylinder floating container conduit valves 25a, 25d are then both opened (see FIG. 2), regardless of what level the tidal body of water 2 is at. Water is consequently siphoned from the floating container 5 so that the floating container 5 rises as a consequence of buoyancy and the siphoning conduit 6 also rises. As the floating container 5 rises, the distal end of the second lever portion 15 moves downwards in opposition to the distal end of the first lever portion 14 connected to the floating container 5. The piston 10 in the cylinder 11 is consequently drawn downwards producing suction 25 which draws fluid into the cylinder 11 which is water from the floating container 5 via the piston cylinder floating container conduit 21.

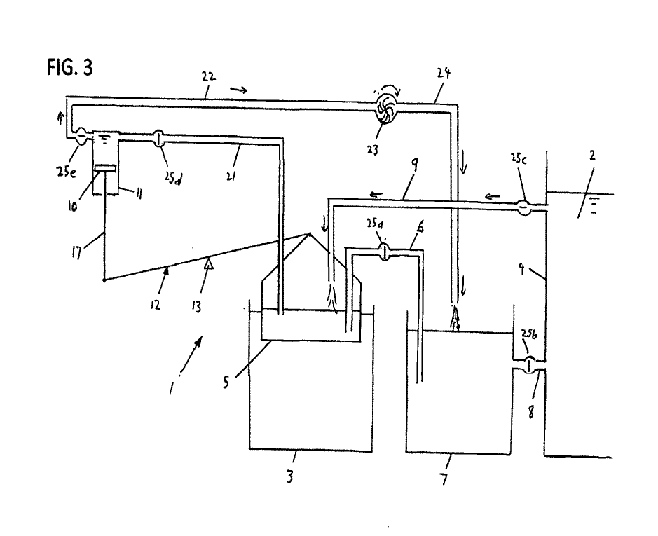

The siphoning conduit and the piston cylinder floating container conduit valves 25a, 25d are both then closed and the replenishing conduit valve 25c opened when the tidal body of water 2 is towards or at high tide level which is higher than the surface of water in the floating container 5 (see FIG. 3).

The floating container 5 is replenished with water from the tidal body of water 2 so that the floating container 5 falls as a consequence of its reduced buoyancy as does the siphoning conduit 6. The water in the cylinder 11 above the piston 10 is compressed as the floating container 5 falls and the piston cylinder turbine conduit valve 25e is opened so that pressurized water is forced through the piston cylinder turbine conduit 22 to drive the turbine means 23 and generate electricity.

Thus, the apparatus 1 produces pressurized water from a tidal body of water 2. As the weight of water in the floating container 5 may be thousands of tones and the cylinder 11 has a relatively small cross-sectional area, high pressure is achieved. Water exiting from the turbine means 23 enters the siphoned water reservoir 7 via the turbine exit conduit 24.

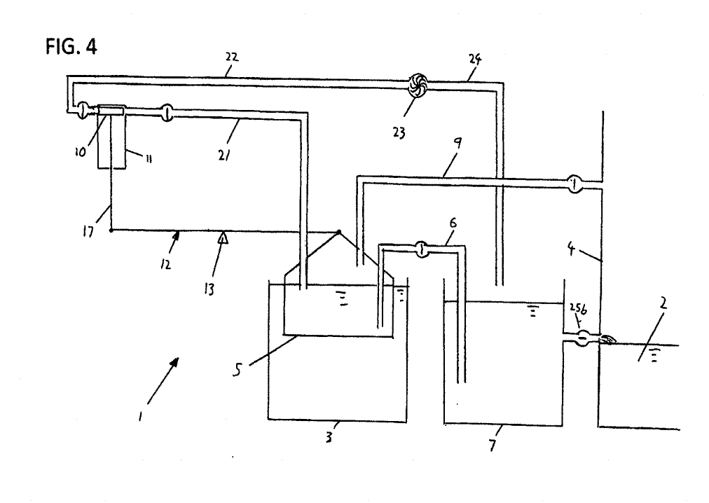

When the tidal body of water 2 subsequently lowers to a low tide level, the surface of the water in the siphoned water reservoir 7 is higher than the surface of the tidal body of water 2 (FIG. 4).

The siphoned water reservoir exit conduit valve 25b is opened so that water in the siphoned water reservoir 7 drains into the tidal body of water 2.

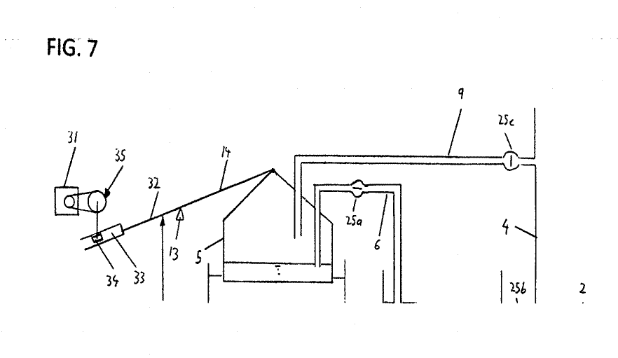

A modified apparatus is illustrated in FIG. 7 and is used to drive a dynamo 31 to produce electricity. The second lever portion 32 has a groove 33 5 in which slides a slider 34. The slider 34 forms part of a transmission mechanism 35 that connects the lever 36 to the dynamo 31 wherein the mechanism 35 converts the reciprocating motion of the second lever portion 32 into rotational motion which drives the dynamo 31.

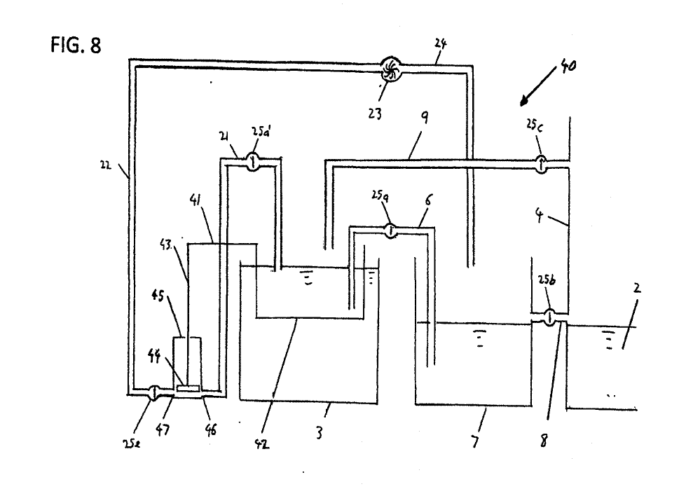

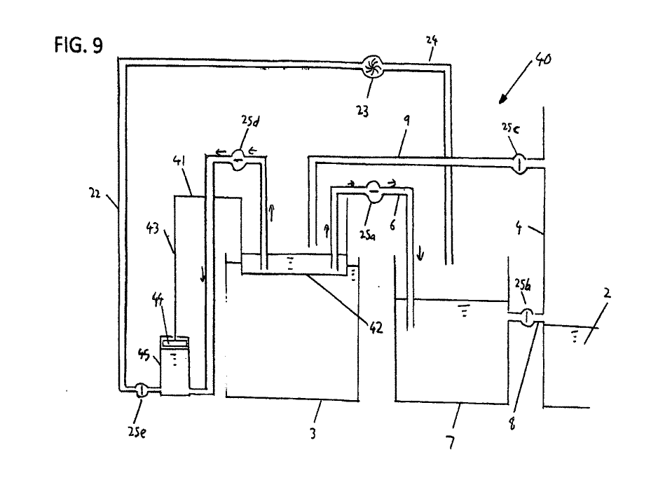

Referring to FIG. 8 and FIG. 9, an apparatus 40 according to a second 10 embodiment of the invention has an arm 41 extending away from the top of the floating container 42 and the piston shaft 43 extending in a downward direction from the arm 41 with the piston 44 in the cylinder 45 being at the base of the shaft 43. The first and second ports 46, 47 are proximate the base of the cylinder 45.

When water is siphoned from the floating container 42, the piston 44 is raised in the cylinder 45 sucking water into the cylinder 45 from the floating container 42 (FIG. 9). When the floating container 42 is replenished with water from the tidal body of water 2, the floating container 42 falls causing the piston 44 to pressurize the water therein. Operation is basically the same as 20 that described with reference to FIG. 1 to FIG. 4 apart from the connection between the floating container and the piston shaft.

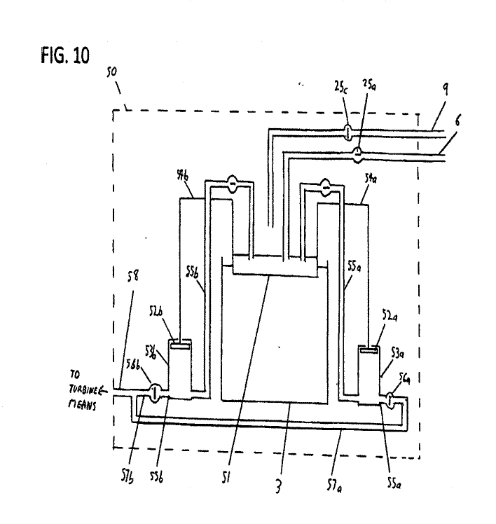

A water pressurizing system 50 is illustrated in FIG. 10 and comprises the main reservoir 3 which has its floating container 51 modified so as to be connected to a plurality of pistons 52a, 52b in respective piston cylinders 53a, 25 53b of the system 50 via respective arms 54a, 54b extending away from the container 51. A separate piston cylinder fluid container conduit 55a, 55b extends from each piston cylinder 53a, 53b to the floating container 51 and the second port 55a, 55b of each piston cylinder 53a, 53b has an associated valve 56a,56b. There is an outlet conduit 57a, 576 from each valve 56a, 56b and the conduits 57a, 576 join together to form a single conduit 58 leaving the system 50 and which is connected to the turbine means (not shown). The siphoning conduit and the replenishing conduit valves 25a, 25c for the siphoning conduit 6 and replenishing conduit 9 associated with the floating container 51 form part of the system 50.

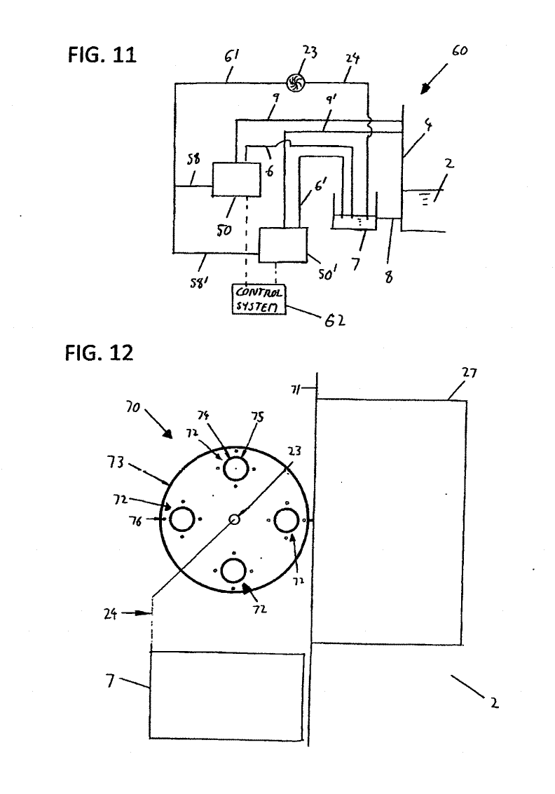

Referring to FIG. 11, an apparatus 60 is shown having a plurality of water pressurizing systems 50, 50′ which all supply pressurized water to the turbine means 23. The outlet conduit 58, 58′ from each system 50, 50′ join together to form a single conduit 61 leading to the turbine means 23. Theme is a separate replenishing conduit 9, 9′ from the tidal body of water 2 to replenish 10 the floating container (not shown) in each water pressurizing system 50, 50′ and a separate siphon conduit 6, 6′ from each floating container to the siphoned water reservoir 7. The valves (not shown) of each water pressurizing system 50, 50′ are controlled by a control system 62.

The apparatus 60 is arranged to provide a regular flow of pressurized 15 water to the turbine means 23. This may be done by siphoning water from the floating container in the water pressurizing system 50 so that the floating container rises causing the system 50 to provide pressurized water. Water is then siphoned from the floating container in the water pressurizing system 50′ so that the floating container rises causing that system 50′ to provide 20 pressurized water. Thus, where there are a plurality of water pressurizing systems, each system is operated sequentially so that a regular flow of pressurized water is supplied to the turbine means 23.

Any suitable arrangement of conduits may be used to connect the floating containers to the turbine means 23, to siphon water from the floating containers 25 and to replenish the floating containers.

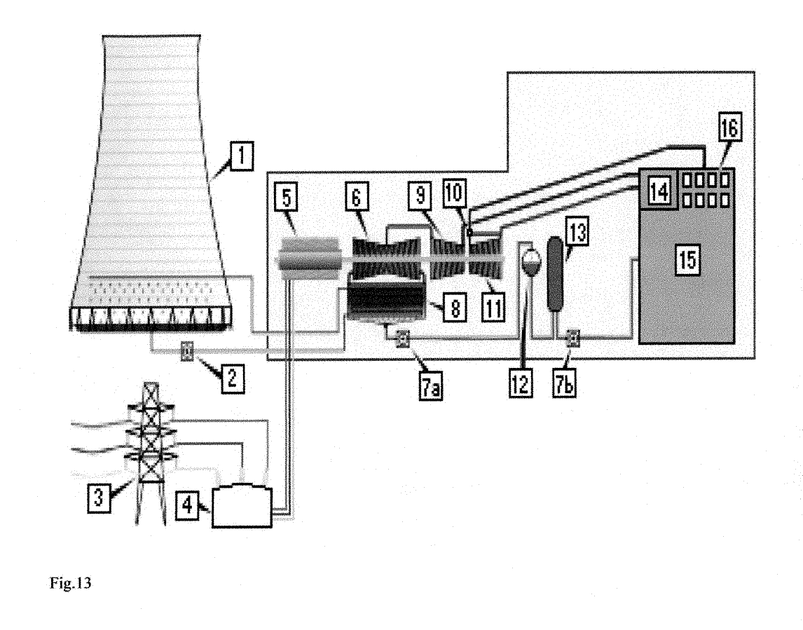

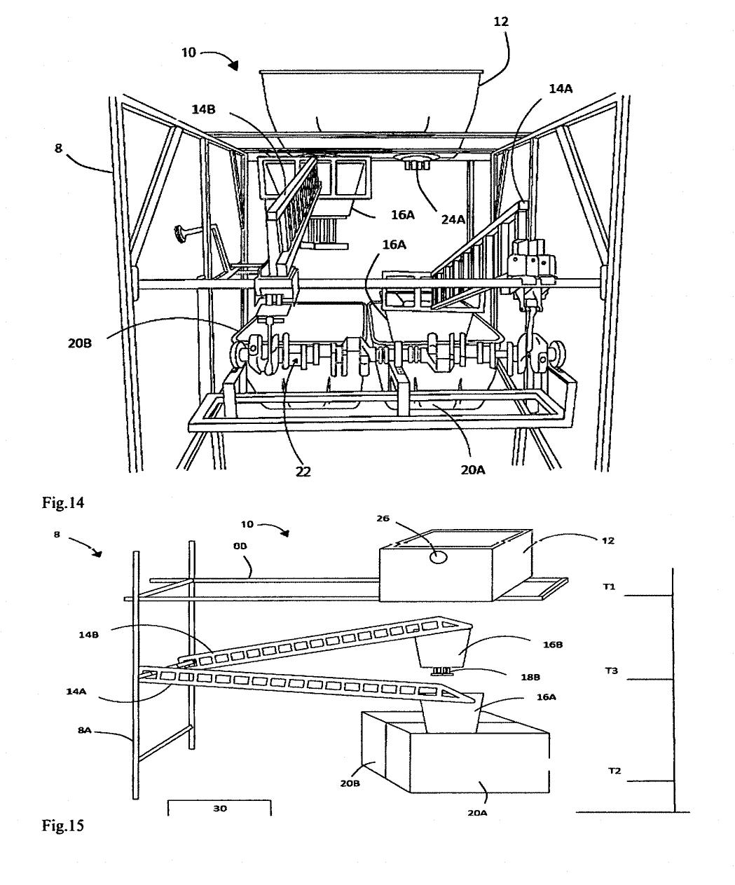

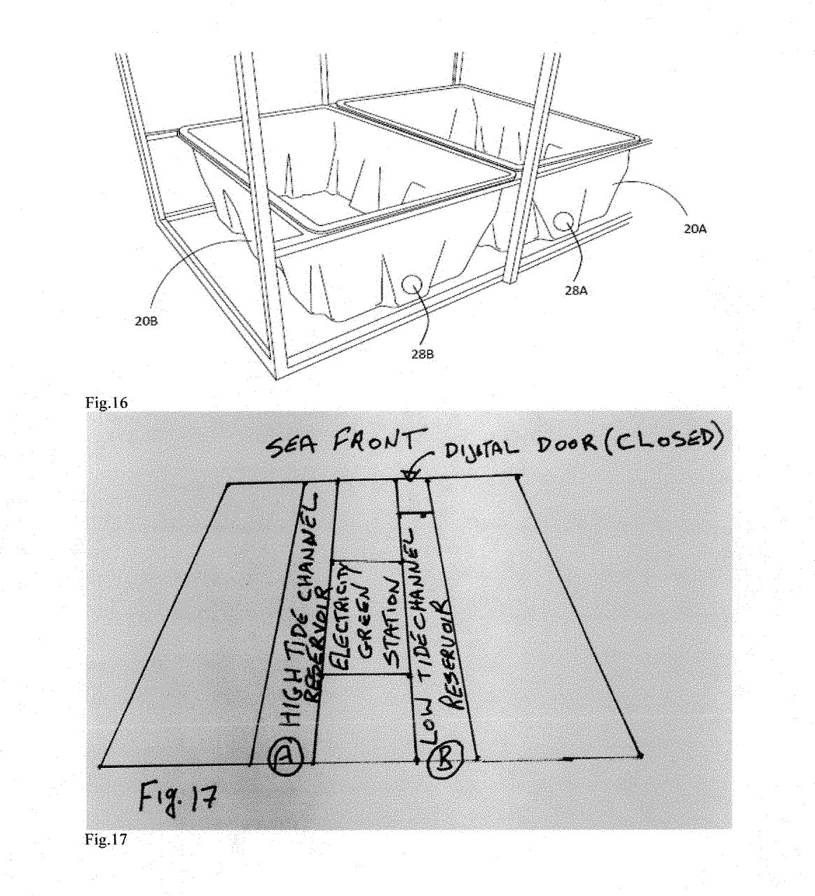

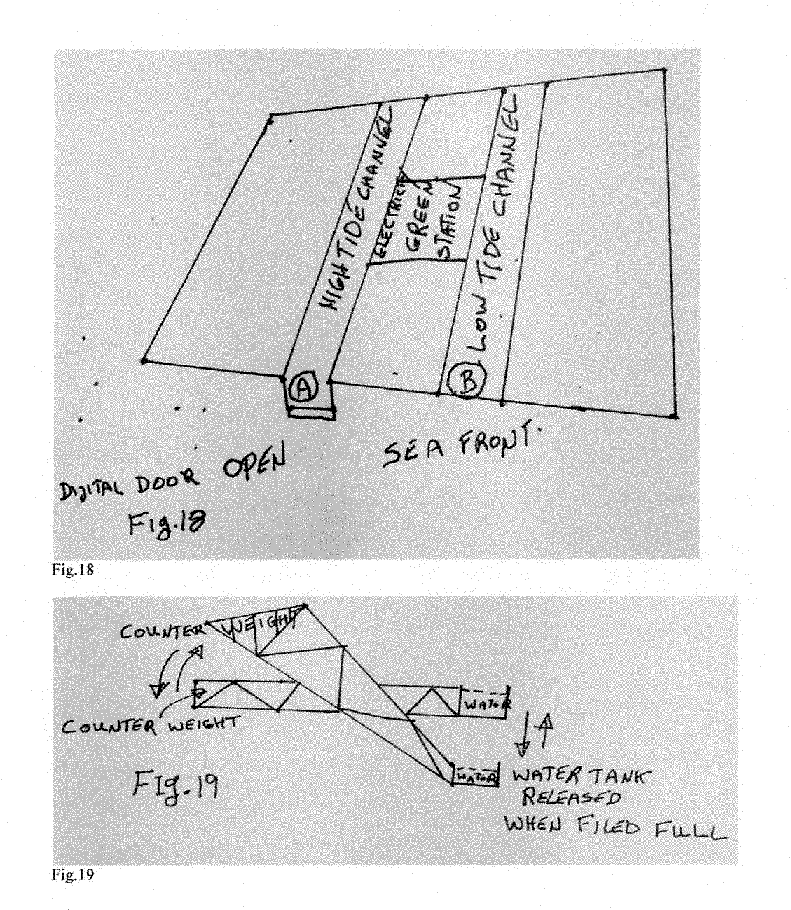

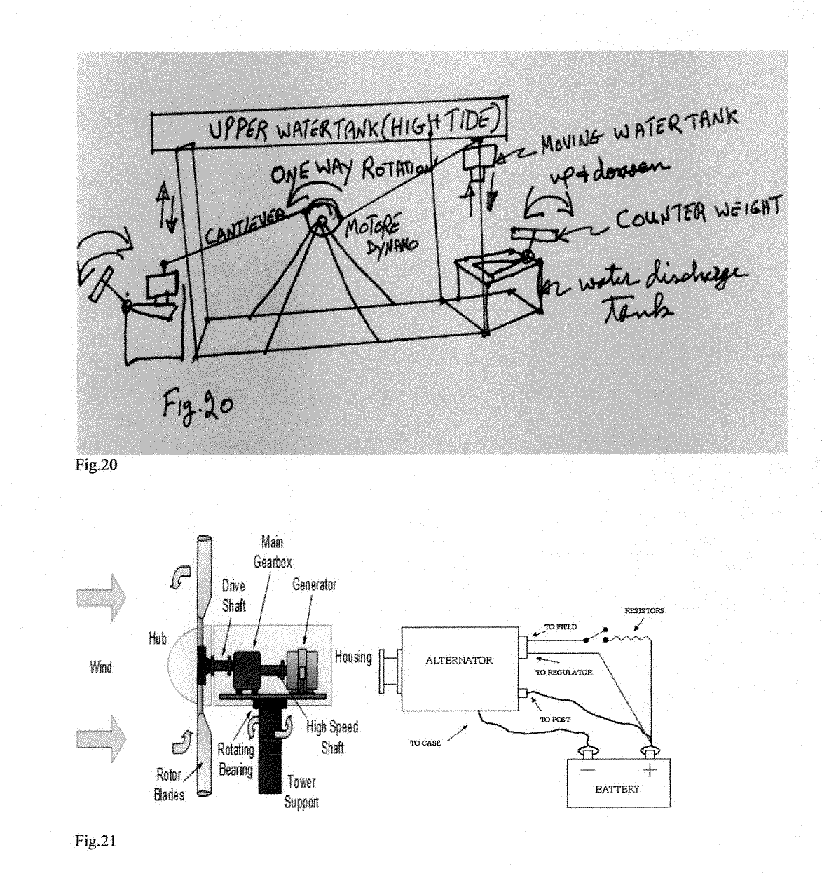

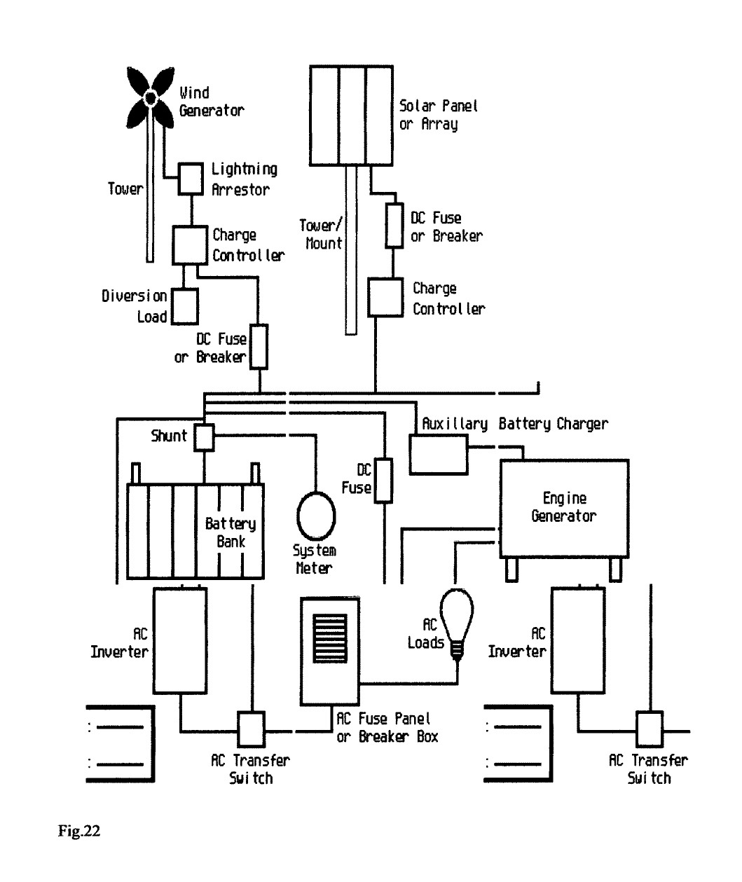

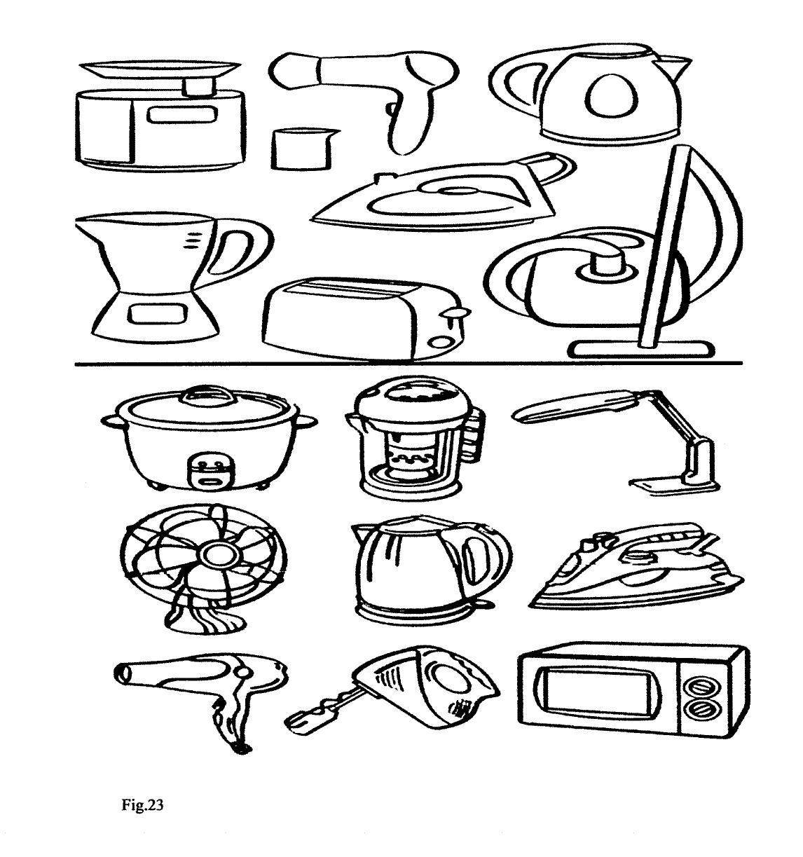

Referring to FIG. 12, another apparatus 70 is shown having a high tide storage reservoir 27 against one side of a boundary wall 71 and the tidal body of water 2 surrounds the high tide storage reservoir 27 beyond the wall 71. A plurality of water pressurizing systems 72 are contained in an enclosure 73 on the other side of the wall 71 wherein the floating container 74 in the main reservoir 75 in each system 72 is arranged to replenished from the high tide storage reservoir 27.

Each water pressurizing system 72 has four piston cylinders 76 and the outlet from each system 72 is connected to the turbine means 23. The turbine exit conduit 24 extends from the turbine means 23 to the siphoned water reservoir 7 and water stored therein can be returned to the tidal body of water 2 at low tide. The control system, siphoning and replenishing conduits, and conduits between the water pressurizing systems 72 and the turbine means 23 are omitted for clarity. Each water pressurizing system 72 is operated sequentially to provide a regular flow of pressurized water to the turbine means 23.

In a specific example, the high tide storage reservoir 27 has a length of 50 m and a width of 30 m, the enclosure 73 has a diameter of 30 m, the floating Container 74 and main reservoir 75 of each water pressurizing system 72 have respective diameters of 4.5 m and 5 m. The siphoned water reservoir 7 has a 15 length of 30 m and a width of 20 m.

Whilst particular embodiments have been described, it will be understood that various modifications may be made without departing from the scope of the invention.

### Two Tanks or Several Tanks Apparatuses

Elements in the figures have not necessarily been drawn to scale in order to enhance their clarity and improve understanding of these various elements and embodiments of the invention.

Furthermore, elements that are known to be common and well understood to those in the industry may not be depicted in order to provide a clear view of the various embodiments of the invention; thus the drawings are generalized in form in the interest of clarity and conciseness. FIG. 14; (This Driving apparatuses system applies to all Green Electricity Generators used in this non provisional patent), Turning the shaft (or compressing pressure pistons) using the moving tanks weight-filling and discharging-(10 m long×10 mwide×1 mht) filled with sea water=100 Ton weight) with 10-20 m Cantilevers giving huge Torque

FIG. 15 Right hand Water tank discharging into lower tank from & left hand water tank filling from upper tank &Shafts going up and down rotating the Generator shaft

FIG. 16 showing the lower fixed tanks with the fixed water tanks 20A&20B

FIG. 17&FIG. 18 is a perspective views of reservoirs that may be used in the system for generating green energy, TWO CHANNELS ONE (LEFT) FOR HIGH TIDE ALWAYS ABOVE 1 m AND THE RIGHT LOW TIDE CHANNEL ALWAYS 1 m BELOW THE HIGH TIDE LEVEL (SEE DIGITAL CONTROL DOORS OR ONE WAY VALES

FIG. 19 The counterweights used in holding the moving tanks until the required water weight filled the moving tanks then the water released and one tank move downward due to the weight of the water is heavier than the counterweight and the other tank moves upward as it will be empty of water and both tanks are connected to rope or chain through pulley, The counterweights used in holding the moving tanks

FIG. 20 First prototype station design generating electricity successfully using Dynamo of bicycle and pressurized water to turn small water turbine

Water pressurized & bicycle Dynamo operated using Prototype apparatus above with upper tank as High Tide Reservoir and the Floor as the Low tide Reservoir 1^{sT} trial tests

FIG. 21 Wind generators are used to generate electricity up to 6300 KW when rotating at 11-17 RPM

FIG. 22 Schematic drawing of solar and wind generator green station arrangements to give green energy

FIG. 23 Prototype Electricity Station built in Bahrain on the inventor expense but land was given to the project by the Government of Bahrain with complete success HOUSE HOLD ELECTRIC EQUIPMENTS OPERATED BY THE PILOT GREEN ELECTRICITY STATION, OPERATED TOGETHER ALL ON, (UNLIMITED KW, MW POWER CAN BE GENERATED) AS SEA HIGH TIDE MASS UNLIMITED &FREE, JUST MORE TANKS Two flash lights (100 watt each)+computer, ALL ON, Household TV, ALL ON, Vacuum cleaners (1600 watt), Batteries Bank used to store electricity at night or when no sun or wind, inverter change the batteries DC to (110-220)V, ALL ON together

### DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Embodiments of the present invention will now be described, by way of example, with reference to the accompanying drawings. While particular embodiments have been described, it will be understood that various modifications may be made without departing from the scope of the invention.

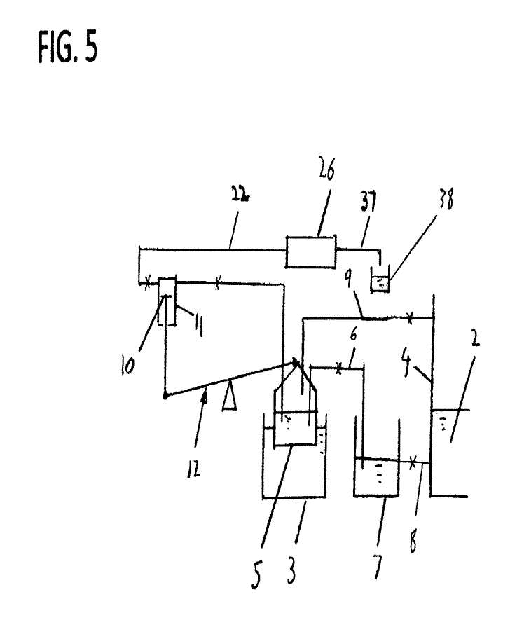

A) The Floating Tank Apparatuses See (FIG. 1 to FIG. 12)

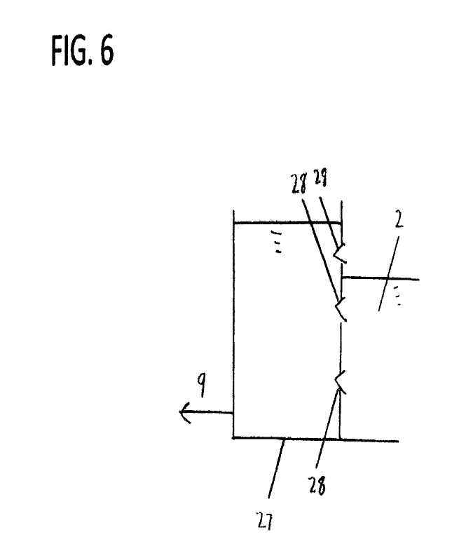

In another modification illustrated in FIG. 6, the barrier may be replaced by a high tide storage reservoir 27 connected to the tidal body of water by one way valves 28. The reservoir 27 is filled at high tide through the one way valves 28 and when the tide subsequently lowers, the water is retained in the reservoir 27. The floating container reservoir into tidal body of water 2. In a first specific example, the high tide storage reservoir 27 may have a length of 50 m, a width of 30 m and a height of 4 m. This would be suitable for a difference of 1.5 m-2.5 m between the low and high tide levels of the tidal body of water. In a second specific example, the high tide

Storage reservoir 27 may have a length of between 1000 m-2000 m, a width of Between 250 m-500 m, and the wall of the reservoir 27 may be at a height of between 1 m-2 m above the maximum high tide level.

In a further modification, the siphoned water reservoir exit is connected to a second reservoir, similar to the high tide storage reservoir 27 and of a similar size to the second specific example of the reservoir 27. The second reservoir is connected to the tidal body of water by at least a single one way valve that prevents water from entering the second reservoir when the level of the tidal body of water is above the valve and the level of water in the second reservoir is approximately the same as the tidal body of water at a low tide level. Water may drain from the second reservoir to the tidal body of water via the one way valve when the tidal body of water at a low tide level. The second reservoir may replace the siphoned water reservoir 7.

The system comprises a tank located at approximately a high tide level and configured to receive and be filled with sea water when the tide is high (FIG. 1 valve 25c); first and second normally-closed tank valves in the bottom of the tank; a reservoir located at approximately a low tide level (FIG. 1&2 valve 25b); first and second cantilever arms located below the tank and above the reservoir, each cantilever arms connected at an inner end to a crankshaft configured to power a device, the first and second cantilever arms are pivotal between raised position and a lowered position such that when the first cantilever arm is in the raised position, the second cantilever arm is in the lowered position; (using rope or chain system so one container is up the other container is down) a first container secured to an outer end of the first cantilever arm and a second container secured to an outer end of the second cantilever arm, the first and second containers positioned under the first and second tank valves, respectively; and first and second normally-closed container valves in the bottom of the first and second containers, respectively. When the first cantilever arm is in the raised position, the first tank valve is opened and allows water to flow out of the tank into the first container and simultaneously the second cantilever arm is in the lowered position, the second container valve is opened and allows water to flow out of the second container into the reservoir. When the first container is filled to a predetermined level and the second container is empty, the first cantilever arm moves to the lowered position and the second cantilever arm moves to the raised position. When the second cantilever arm is in the raised position, the second tank valve is opened and allows water to flow out of the tank into the second container and simultaneously the first cantilever arm is in the lowered position, the first container valve is opened and allows water to flow out of the first container into the reservoir and, when the second container is filled to a predetermined level and the first container is empty, the second cantilever arm moves to the lowered position and the first cantilever arm moves to the raised position. The raising and lowering of the first and second cantilever arms drives the crankshaft, thereby powering the device.

All of the above Green Energy apparatuses and methods and systems can be placed miles away from the sea front where a cheaper land can be used for the green energy stations buy making two channels connected to the sea using sliding doors (DIGITAL CONTROL DOORS OR ONE WAY VALES as described above), between the channels and the sea FIG. 2 &FIG. 3 one channel will have one way valves (or DIGITAL CONTROL DOORS) so sea water can enter-IN but not out of the channel always at near the HIGH TIDE LEVEL and the other channel will have an opposite one way valve (or DIGITAL CONTROL DOORS) sea water-OUT but not IN and the level in this channel always at near LOW TIDE LEVEL.

Both of the above channel depths are independent of the sea level.

In-between these two channels the green energy station will be placed at depth of its floor is deeper (say one meter lower level than the sea low tide level) than the SEA LOW TIDE LEVEL and that's what will make all the water collected after the lower tank open its valves on the low tide level and empty its water level of tank (7) FIG. 1. Or the bottom of tank number 20 FIG. 1 Assuming 6 hr tides interval for high & low tides=(D=1 m, can be much higher) meters the difference in tide highest& lowest, let's assume 6 AM high tide & 12 AM low tide then until the low tide rise to 1 m, (can be much higher) (OUR MINIMUM WORKING HEIGHT AS DESIGNED), the moving tanks take water from the sea high tide directly (from 6:0 AM until say 9 AM) and then the tanks start taking water from the high tide channel store until the normal sea level go up to reach 1 m again at say 3 PM above the low tide level then the high tide channels start taking sea water from the upcoming high tide for both the high tide storage tank and directly to the moving tanks and so on, Similarly the low tide channels will react in opposite manner so to disperse water to the sea directly when the sea level is lower level and then taking the sea water from the low tide storing channels until the level in the low tide channel can be discharged as reaction to the water coming from the high tide channels.

Using ONE way valves or sliding digital control doors) on both storage tanks INN & OUT and Digitally controlled valves with all other controls of the Station & its controllers it should be noted that the ground level above high tide level at least 1 m or more

### B) The Two Tanks Apparatuses (FIG. 14 to FIG. 23)

In the following discussion that addresses a number of embodiments and applications of the present invention, reference is made to the accompanying drawings that form a part hereof and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address, one of the problems discussed above. Further, one or more of the problems discussed above may not be fully addressed by any of the features described below. Embodiments of the present invention will now be described, by way of example, with reference to the accompanying drawings. While particular embodiments have been described, it will be understood that various modifications may be made without departing from the scope of the invention.

FIG. 14 is schematic view of a system for generating green energy from a tidal body of water. The system includes a frame 8 having a vertical section 8A and a horizontal section 8B, FIG. 15 one end of which (the inner end) is connected to the vertical section 8A near the top of the vertical section 8A at approximately a high tide level T1. A tank 12 is secured to the outer end of the horizontal section 8B (that is, the end of the horizontal section 8B opposite the inner end) FIG. 15. Two or more horizontally spaced-apart cantilever arms 14A, 14B FIG. 15 are pivotally connected at their inner ends to the vertical section 8A of the frame 8 at an intermediary height T3. A container 16A, 16B is secured to an outer end of each cantilever arm 16A, 16B. The length of each cantilever arm 14 is such that the containers 16A, 16B are positioned beneath the tank 12. A normally-closed, spring-loaded or piston-driven, one-way valve 18A is located in the bottom of the container 16A (a similar valve is located in the bottom of the other container 16B but not shown in the FIG. 14.). A reservoir 20A, 20B (see also FIG. 23) is located beneath each container 16A, 16B at approximately a low tide level T2. (Alternatively, a single reservoir may be located under both containers 16A, 16B.) As illustrated in FIG. 21, the tank 12, containers 16A, 16B, and reservoirs 20A, 20B are vertically aligned with each other. The containers 16A, 16B may be fabricated from any of a number of water resistant materials, including fiberglass and stainless steel.

FIG. 14 is an end perspective view illustrating further details of the system. The cantilever arms 14A, 14B are supported on a shaft and connected through appropriate linkages to a crankshaft 22 FIG. 14 in such a way that when one of the cantilever arms is in a raised position (the left cantilever arm 14A in FIG. 14) with its container 16A against the bottom of the tank 12, the other is in a lowered position (the right cantilever arm 14B in FIG. 15) with its container 16B in the corresponding reservoir 20B. When a cantilever arm, such as the left arm 14B, is in the raised position, as illustrated in FIG. 14, a normally-closed, spring-loaded or piston-driven valve (not shown no 18 in FIG. 14) in the bottom of the tank 12 is pushed into an open position. Similarly, when the other cantilever arm 14A, is in the raised position, another spring-loaded or piston-driven, one-way valve 24A in the bottom of the tank 12 is pushed into an open position. When a cantilever arm, such as the right arm 14A, is in the lowered position, as illustrated in FIG. 14, the valve (not shown) in the bottom of the container 16A is pushed into an open position. Similarly, when the other cantilever arm 14B, is in the lowered position, the valve 18B (FIG. 14) in the bottom of the container 16B is pushed into an open position. To make sure that this system is completely working using Rope or Chain which is connected through Pulley to both cantilevers 14 A and 14 B, also counterweight are attached to both tanks so each tank will not fall downward until it is fully filled to the required weight and this is done using Counterweight arrangement as show in (FIG. 19)

In operation FIG. 15, at high tide (level T1) a one-way valve 26 in the tank 12 opens to the sea and fills with sea water. With one of the cantilever arms, such as the left arm 14B, in the raised position, the corresponding valve in the bottom of the tank 12 is open and allows water to flow from the tank 12 into the container 16B on the end of the cantilever arm 14B. A counter-weight (not shown) may be used to keep the arm 14B in the raised position until it has filled with water to a predetermined level. The other cantilever arm 14A is in its lowered position and the container 16A on the end of the arm 14A is empty. The full container 16B outweighs the empty container 16A; gravity causes the full container 16B to overcome the counterweight and fall to its lowered position and the empty container 16A to rise to its raised position. When the full container 16B is in its lowered position, the valve 18B in its bottom is pressed open against its spring, allowing water to flow out through the valve into the reservoir 20B simultaneously, when the empty container 16A has risen to its raised position, the valve 24A in the bottom of the tank 12 is pressed open against its spring, allowing water to flow out through the valve 24A into the previously empty container 16A. Next, with the right cantilever arm 14A in the raised position, the corresponding valve 24A in the bottom of the tank 12 is open and allows water to flow from the tank 12 into the empty container 16A on the end of the cantilever arm 14A. A counter-weight may be used to keep the arm 14A in the raised position until it has filled with water to a predetermined level. The other cantilever arm 14B is in its lowered position and the container 16B on the end of the left arm 14B has emptied. The newly filled container 16A outweighs the now empty container 16B; gravity causes the full container 16A to overcome the counterweight and fall to its lowered position and the empty container 16B to rise to its raised position. When the full container 16A is in its lowered position, the valve in its bottom is pressed open, allowing water to flow out through the valve into the reservoir 20A. Simultaneously, when the empty container 16B has risen to its raised position, the valve 24A in the bottom of the tank 12 is pressed open, allowing water to flow out through the valve 24A into the previously empty container 16B. When the reservoirs 20A, 20B are full, water is allowed to flow out of them through one-way output valves 28A, 28B.

In addition to installing the system to take advantage of the rising and falling tides of the sea, the system may be installed to take advantage of rising and falling of any other body of water or fluid. As the cantilever arms 14A, 14B rise and fall as their corresponding containers 16A, 16B empty and fill, the attached crankshaft 22 is turned and is available to power any device connected to the crankshaft 22, such as an electrical generator used to directly provide power or to charge batteries, pump, desalination, and other mechanically or electrically powered device. In one embodiment, the cantilever arms 14A, 14B and crankshaft 22 are configured such that one complete cycle rising and falling of the right and left cantilever arms 14A, 14B causes the crankshaft 22 to make one complete rotation or more turns depending on the crankshaft designs or using gears or pulleys to change the rotation of the crankshaft.

It will be appreciated that the cantilever arms 14A, 14B may be connected using means other than, or in addition to, the illustrated crankshaft 22. For example, gears or pulleys and chains/ropes may be used to reduce the amount of water needed by providing a mechanical advantage. The cantilever arms 14A, 14B may also be on opposite sides of the vertical section 8A of the frame 8. The cantilever arms 14A,14B may also be connected to hydraulic pistons which may use fluid, such as oil, to pressurize other pistons and, using the resulting mechanical advantage, drive other devices such as, for example, reverse osmosis desalinations, rotary engines, impulse turbines, hydrogen liquefiers, petroleum gas liquefiers, to name a few. Among other uses, the liquefied gas may be used in an air conditioning unit for cooling or heating of buildings and houses. It will also be appreciated that, although only a single set of cantilever arms 14A, 14B, containers 16A, 16B, and associated valves, the system may be expanded to include more than one set connected through linkages to the crankshaft 22 for a greater mechanical power output. the same element numbers will be used as were used in the description above of the individual components.

For advanced control of the components, a computer controller may be integrated into the system to coordinate and monitor the operation of the valves 18A, 18B, 24, 26, 28A, 28B, and other components

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

{All of the Successful Prototype Electricity stations were built& tested on the Inventor Expense and no financial help were asked for at all}.

1) A method of pressurizing fluid or rotating shafts of electricity generators using the weight of a tidal body of water, using two methods with the same principals
Using a tidal body of water, described in this invention comprising the steps of (FIG. 1 to FIG. 12 for The Floating Tanks Methods &apparatuses and (FIG. 16 to FIG. 52) for The Two or several Moving Tanks method apparatuses using Generators, as the sea water is free and has unlimited waters in the sea high tides the apparatus free running as no gas or oil or engines needed, just generators coils very few maintenance staff, tanks and pipes as large as needed to construct-MW-GW and will work almost anywhere as only 1.5 m High Tide sea level above the Low Tide sea level needed using the high tide and low tide channel system, which make this invention has Unlimited generating capacity and can used for desalination plants, liquid hydrogen for cars fuel, cooling and heating for houses and buildings, or for any amount of energy needed for any project which make this invention very economical and green and will be very suitable for isolated island in the sea, the system wherein the tidal body of water may be replaced by any other body of rising and falling water and it is possible for the state MAINE—BAY OF FUNDY, USA to supply electricity to many states because it has the highest tides in the world 15-16 meters (50 ft+) with tides of 100KM3 volume of water in and out of tides at very low prices.

2) The apparatus of the high tide-low tide station does not need to be located
Next to the tidal body of water of the sea front, as conduits or pipes can be used to transport
Water from the tidal body of water to the electricity generating station using gravitation
